(19) United States
(12) Patent Application Publication
(10) Pub. No.: US 2014/0280783 A1
(43) Pub. Date: Sep. 18, 2014

(54) Method and Apparatus for Improving Downloading Performance Based on Reading Intent for Digital Magazine

(71) Applicant: Haixiang He, Foster City, CA (US)

(72) Inventor: Haixiang He, Foster City, CA (US)

(21) Appl. No.: 14/214,303

(22) Filed: Mar. 14, 2014

Related U.S. Application Data
(60) Provisional application No. 61/786,607, filed on Mar. 15, 2013.
(60) Provisional application No. 61/786,613, filed on Mar. 15, 2013.

(51) Int. Cl. H04L 29/08; H04L 12/911

(52) U.S. Cl. CPC H04L 67/06; H04L 47/70
USPC 709/219

(57) ABSTRACT

A method for improving downloading performance of digital magazine in OFIP (Open Format Interactive Publishing) format or Folio format based on reading intent is disclosed. In one embodiment, the method is realized by packaging the whole issue of digital magazine into per article based or per page based record based on meta-data analyzing the reading intent, e.g. which article and which page a user is currently reading, which article and which page the user intents to read next, downloading only resources related to those articles and pages, and displaying the article or the page as soon as the related resources are downloaded.

### CROSS-REFERENCE TO RELATED APPLICATIONS

This patent application claims priority to U.S. Provisional Patent Application No. 61/786,607, entitled “Method and Apparatus for Improving Downloading Performance of Digital Magazine in Folio Format Based on Reading Intent”, filed on Mar. 15, 2013 and naming Haixiang He as inventor, the disclosure of which is hereby incorporated herein, in its entirety, by reference.

This patent application claims priority to U.S. Provisional Patent Application No. 61/786,613, entitled “Method and Apparatus for Improving Downloading Performance of Digital Magazine in OFIP (Open Format Interactive Publishing) Format Based on Reading Intent”, filed on Mar. 15, 2013 and naming Haixiang He as inventor, the disclosure of which is hereby incorporated herein, in its entirety, by reference.

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of digital magazine. More particularly, the present invention is in the technical field of improving content downloading performance for digital magazine. Furthermore, the present invention is in the technical field of using reading intent to improve content downloading performance.

### BACKGROUND OF THE INVENTION

Print magazine has been digitalized for years to make it possible for people to access it using digital devices including computers, phones, tablets, etc. Recently, with the advance of technologies from both digital magazine creation tools and digital magazine consumption devices, multimedia and interaction content is added into digitalized print magazine. And enhanced digital magazine delivers a super consumer experience that print magazine just cannot achieve.

With all these additional multimedia and interactive content, digital magazine is huge in size. A typical issue of digital magazine in OFIP (Open Format Interactive Publishing) format or Folio format has about 100 M to 600 M in size. For a user to read an issue of digital magazine, the issue needs to be downloaded from content hosting server to the user's content consumption device over the Internet especially over the mobile Internet.

Due to the huge size of an issue of digital magazine, it will take a long time for the digital magazine to be downloaded from content server to content consumption device especially through slow Internet connection. Hence the user has to wait for a long time and user experience is not good.

Users definitely don't like to wait. How to make the downloading faster without changing reading experience is becoming important. And hence, such a method and apparatus is desired.

### SUMMARY OF THE INVENTION

The present invention is a method and apparatus to improve content downloading performance of digital magazine.

Many publishers use OFIP (Open Format Interactive Publishing) format or Folio format to publish their latest multimedia and interactive digital magazines for iPad and other tablet and mobile devices. The format enables publishers to add multimedia content including video, audio, and slide show, into the typical print magazine content. It also enables publishers to add interaction into the typical print magazine content. The format enables publishers to deliver super reader experience than other digital formats such as PDF.

The latest multimedia and interactive digital magazine in OFIP format or Folio format divides a whole magazine issue into articles and divides each article into pages. Each article or each page has its own content resources including video, audio, image, etc. for rendering. Each article or each page also has its own meta-data to specify the resources as well as interactions for rendering.

Currently, all resources of an article or a page need to be downloaded from content hosting server to the user's content consumption device before the article or the page can be rendered by the user's content consumption device. Since the size of each article or each page can be huge, it can take a long time for the article or page to be completely downloaded from content server to content consumption device especially through slow Internet connection. Hence the user has to wait for a long time and user experience is not good.

This invention analyzes the reading intent, e.g. which article and which page a user is currently reading, which article and which page the user intents to read next. Then based on a user's reading intent, it identifies the content resources required for rendering those articles and pages, and only downloads those resources from the server first instead of all resources of those articles and pages that may not needed for rendering the articles or pages the user is reading or intents to read. Hence it reduces the size of the content can improve downloading performance but without impacting reading experience.

The digital magazine server must have the capability to process the digital magazine in OFIP format and based on the meta-data to identify content resources related to each article or each page. In addition, the server must have the capability to package per article or per page based content resources into a format that can be rendered by the same reader that can render the digital magazine as a whole.

The digital magazine reader must have the capability to render an article or a page of the digital magazine once the content resources for that article or that page have been downloaded from server. In another word, the reader will not need to download unnecessary resources before it starts rendering the content. Hence, it will improve the downloading performance. The reader must have the capability to communicate with the digital magazine server about the reading intent, e.g. which article or which page to render, accordingly on top of other normal communication between reader and server.

Those skilled in the art will appreciate the scope of the present invention and realize additional aspects thereof after reading the following detailed description of the preferred embodiments in association with the accompanying figures.

### BRIEF DESCRIPTION OF THE DRAWINGS

The present invention is illustrated by way of example in the following drawings in which like references indicated similar elements. The following drawings disclose various embodiments of the present invention for purposes of illustration only and are not intended to limit the scope of the invention. For purposes of clarity, not every component may be labeled in very figure. In the figures:

FIG. 1 is a functional block diagram of a digital magazine processing and hosting server according to an embodiment of the present invention;

FIG. 2 is a functional block diagram of a digital content storage according to an embodiment of the present invention;

FIG. 3 is a flow diagram of a process of improving downloading performance of digital magazine based on reading intent according to an embodiment of the present invention.

### DETAILED DESCRIPTION OF THE INVENTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

FIG. 1 is a functional block diagram showing the relevant components of an example digital magazine processing and hosting server 100 that may be used to process and host digital magazines. Digital magazine processing and hosting Server has hardware platform and software applications. In the embodiment shown in FIG. 1, the digital magazine processing and hosting server 100 includes an input logic 110 configured to enable the uploading of digital magazines. It also includes processing logic 120 configured to process digital magazines based on the meta-data associated with digital magazines. After processing the digital magazine, the processing logic 120 will store digital magazines in digital magazine storage 130.

In the embodiment shown in FIG. 1, digital magazines are stored in digital magazine storage 130. The digital magazine processing and hosting server 100 contains an Internet logic 140 configured to receive digital magazine downloading request from and to transmit digital magazine resources to external entities. Upon receipt of digital magazine downloading request, the serving logic 150 will decide which digital magazine resources it needs to retrieve from the digital magazine storage 130 and transmit those resources to external entities through the Internet logic 140. In another embodiment of the present invention, the digital magazine storage 130 may reside outside the device and connect over Internet especially mobile Internet with digital magazine processing and hosting server 100 through Internet logic 140.

Input logic 110 and processing logic 120 may reside outside the digital magazine processing and hosting server 100 in another embodiment of the present invention. The digital magazine processing and hosting functions can be separated into two devices and connected though digital magazine storage 130.

Digital magazine processing and hosting server 100 may also contain other components.

FIG. 2 is a functional block diagram showing the relevant components of an example digital content storage 200 that can be used to as digital magazine storage 130 in FIG. 1. Digital content database can be any hardware or software that is capable of storing digital content. In the embodiment shown in FIG. 2, the digital content storage 200 includes a number of digital content records 210 configured to store each piece of digital content. Digital content record 210 includes record identifier 212 configured to uniquely identify each piece of digital content, content 214 configured to store the real content part of the digital content record 210, and metadata 216 configured to store information related to the digital content. Digital content record 210 may also contain other fields. Metadata 216 includes a number of data fields 2162 configured to store metadata information related to the corresponding digital content. One data field 2162 is geographic area(s) 2164 configured to store defined real-world geographic area(s). Digital content can be any type of digital content including digital music, digital video, eBook, etc., according to an embodiment of the present invention.

The digital magazine reader is used to render the digital magazine including multimedia and interactive content. Digital magazine reader can be any hardware or software that is capable of rendering digital content. In one embodiment, the digital magazine reader includes an Internet logic configured to enable the digital magazine reader to communicate with digital magazine server through Internet especially mobile Internet. Digital magazine reader may also contain digital content storage configured to store digital content. Digital content reader may also contain other components.

FIG. 3 is a flow diagram of a process for improving downloading performance based on reading intent according to an embodiment of the invention. While particular messages may be described in connection with FIG. 3, the invention is not limited to this particular sequence of message as other sequences may be used as well. Also, the messages in the following description have been given particular names for ease of reference. The names of the messages may change without departing from the scope of the invention.

As shown in FIG. 3, the digital magazine reader detects that user is currently reading page #1 and intent to read page #2 that has video and slideshow which size is 70% of all resource side (310). Based on the meta-data of page #2, the digital magazine reader can decide whether video resource is required to render the page #2 immediately or not (320). If the video resource is required to render the page #2 immediately, then add the video resource request to the resource request list (330). If the video is not required, then the reader will not add video resource request and move to next step. Based on the meta-data of page #2, the digital magazine reader can decide whether slideshow resource is required to render the page #2 immediately or not (340). If the slideshow resource is required to render the page #2 immediately, then add the video resource request to the resource request list (350). If the slideshow is not required, then the reader will not add slideshow resource request and move to next step.

Based on the resource request list, the digital magazine reader will send downloading request for only resources in the resource request list to digital magazine processing and hosting server (100). Once receiving the downloading request from digital magazine reader, the digital magazine processing and hosting server will retrieve requested resource from digital magazine storage (130) and transmit the resources to digital magazine reader. Once receiving the resources from the digital magazine processing and hosting server (100), the digital magazine reader will render the page #2 immediately (360). After rendering the page #2, the digital magazine reader can download video and slideshow resources since a user might want to read them next.

It should be understood that all functional statements made herein describing the functions to be performed by the methods of the invention may be performed by software programs implemented utilizing subroutines and other programming techniques known to those of ordinary skill in the art. Alternatively, these functions may be implemented in hardware, firmware, or a combination of hardware, software, and firmware. The invention is thus not limited to a particular implementation.

The control logic in this embodiment may be implemented as a set of program instructions that are stored in a computer readable memory within the network element and executed on a microprocessor on the network element. However, in this embodiment as with the previous embodiments, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. A method of improving downloading performance based on reading intent for digital magazines, the method comprising the steps of:
detecting a reader's reading intent for new article or new page within an issue of a digital magazine;
analyzing and identifying the must-have resources to render the new article or new page based on the digital magazine's meta-data for the new article or new page; and
downloading only must-have resources of the new article or new page and rendering the article or page after completing the download of must-have resources.

2. The method as claimed in claim 1, wherein the digital magazine is in either OFIP or Folio format as well as any other format that has meta-data of the digital magazine.

3. The method as claimed in claim 2, wherein the meta-data of the digital magazine has enough information about the content resources for each article or each page within a magazine issue and enough information about instructions for rendering each article or each page.

4. The method as claimed in claim 1, further comprising analyzing and identifying the must-have content resources to render the new article or new page based on the digital magazine's meta-data.

5. The method as claimed in claim 4, wherein analyzing and identifying the must-have resources comprises identifying whether video content, slideshow content or any other content which are usually big in size are part of the must-have resource or not.

6. The method as claimed in claim 5, further comprising adding video content request, slideshow content request, or any other content request to the content resource request list if they are part-of must-have resources.

7. The method as claimed in claim 5, further comprising not adding video content request, slideshow content request, or any other content request to the content resource request list if they are not part-of must-have resources.

8. The method as claimed in claim 1, further comprising sending content resource request list to digital magazine processing and hosting server and rendering the article or the page after completing the download of must-have resources.

9. The method as claimed in claim 8, wherein the digital magazine processing and hosting server has the capability to understand the content resource request list, to retrieve the requested resources, to package the resources, and to transmit the package of content back to digital magazine reader.

10. A system for improving downloading performance based on reading intent for digital magazines comprising:
a digital magazine processing and hosting server for processing a digital magazine and for hosting the digital magazine over the Internet;
a storage system for storing a content record;
a communication logic for receiving content resource request list and for transmitting content resources;
a resource control logic for analyzing and identifying must-have resources; and
a consumption logic for rendering the article or the page after completing the download of must-have content resources.

11. The system as claimed in claim 10, wherein the resource control logic is defined to analyze the meta-data of the article or the page and to identify must-have content resources for rendering.

12. The system as claimed in claim 11, wherein the resource control logic determines allowing addition of video or slideshow or any other content that is big in size to the content resource request list if they are must-have resources.

13. The system as claimed in claim 11, wherein the resource control logic determines not allowing addition of video or slideshow or any other content that is big in size to the content resource request list if they are not must-have resources.

14. The system as claimed in claim 10, wherein the digital magazine processing and hosting server is defined to process digital magazine in either OFIP or Folio format as well as any other format that has enough meta-data information and to host digital magazine over the Internet.

15. The system as claimed in claim 14, wherein the digital magazine processing and hosting server has a control logic to understand the resource request list, to package the resource, and to transmit the package over the Internet.
